(19) United States
(12) Patent Application Publication
(10) Pub. No.: US 2007/0162366 A1
(43) Pub. Date: Jul. 12, 2007

(54) Anti-phishing communication system

(75) Inventors: Ray Tanaka, San Jose, CA (US); Alan Tien, Sunnyvale, CA (US); Roy Vella, San Francisco, CA (US)

Correspondence Address: SCHWEGMAN, LUNDBERG, WOESSNER & KLUTH/EBAY, P.O. BOX 2938, MINNEAPOLIS, MN, 55402, US

(73) Assignee: EBAY INC., SAN JOSE, CA (US)

(21) Appl. No.: 11/323,989

(22) Filed: Dec. 30, 2005

(51) Int. Cl. G06Q 40/00

(52) U.S. Cl. 705/35

(57) ABSTRACT

A system and method for electronic message verification are described. One embodiment adds a unique code to electronic messages which a user can provide to a financial services company website. The code can be verified and a verification notice is provided to the user if the message was authentic. Authentication can be based upon both the code and the user's identification relative to the financial services company.

### TECHNICAL FIELD

Various embodiments relate generally to the fields of network-based transactions, and in particular, but not by way of limitation, to a system and method including security features.

### BACKGROUND

The Internet and the World Wide Web provide access to a tremendous amount of products and information. Consequently, a consumer can shop for goods on many E-commerce sites on the World Wide Web. Such E-commerce sites permit a user to log on to the site, shop for goods and services online, submit the order to the E-commerce facility's server, and have the goods delivered to the user.

Numerous payment systems can be implemented to conduct electronic commerce transactions. For example, third party financial services companies can be used to facilitate financial transactions. These companies can be traditional credit companies, or e-commerce specific companies such as PayPal. PayPal, an eBay Company, enables any individual or business with an email address to securely send and receive payments online.

Phishing is a fraudulent practice of obtaining confidential consumer information. Phishing attacks can use schemes to steal consumers' personal identity data and financial account credentials. Such schemes often use ‘spoofed’ e-mails to lead consumers to counterfeit websites designed to trick recipients into divulging financial data such as credit card numbers, account usernames, passwords and social security numbers. Hijacking brand names of banks, e-retailers and credit card companies, phishers often convince recipients to respond.

### BRIEF DESCRIPTION OF THE DRAWINGS

The present invention is illustrated by way of example and not limitation in the figures of the accompanying drawings, in which like references indicate similar elements and in which:

FIG. 1 is a flow chart illustrating a prior art electronic transaction;

FIG. 2 is a flow chart illustrating embodiments of the present invention;

FIG. 3 is a block diagram of a system according to embodiments of the invention; and

FIG. 4 illustrates a computer architecture upon which an embodiment of the present invention may execute.

### DETAILED DESCRIPTION

A system and method for email verification are described. In the following description, for purposes of explanation, numerous specific details are set forth in order to provide a thorough understanding of the present invention. It will be evident, however, to one skilled in the art that the present invention may be practiced without these specific details.

As known to those skilled in the art, criminal schemes to fraudulently obtain consumer information hurts the consumer and financial organizations in many ways. A financial institution has the potential of both financial losses and a loss of confidence by consumers. Embodiments of the invention provide an extra level of security to help reduce the likelihood of becoming a victim of phishing scams.

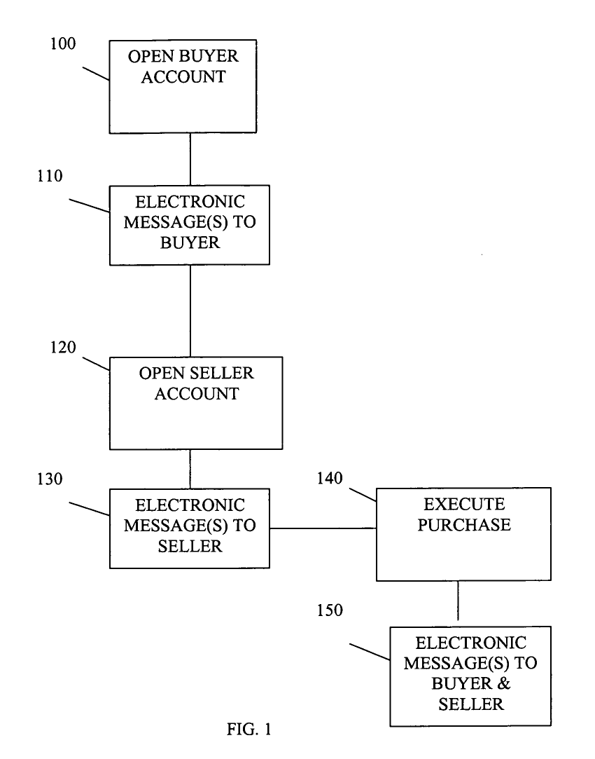

Third party financial institutions for facilitating on-line e-commerce transactions, such as PayPal, provide electronic notifications to account users when a financial transaction has been executed. Referring to FIG. 1, a representative prior art transaction is described. Both the buyer and seller can have an account with the financial service company. At process 100 the buyer opens an account and provides financial information, such as a credit card or bank account, to fund the account for future purchases. The financial service company at process 110 provides one or more electronic messages to the account holder. Electronic messages as used herein comprise any electronic implemented message, including but not limited to email, text messages, voice messages, and instant messages.

Likewise, at 120 the seller opens an account to receive payments from buyers. The financial service company at process 130 provides one or more electronic messages to the account holder.

At process 140 the buyer executes a purchase and authorizes the financial service company to pay the seller. The financial services company at process 150 provides electronic messages to the buyer and seller. The electronic message to the buyer typically includes a confirmation of the transaction paying the seller. The electronic message to the seller can include a notification of the payment and may include details of the transaction.

Fraudulent electronic messages which imitate the electronic messages from the financial services company can be sent to buyers and sellers in an attempt to obtain confidential financial information. That is, a fraudulent seller directed message indicating that a sale was conducted may request the seller provide account information. Embodiments of the invention provide method and systems to authenticate valid electronic messages sent by the financial services company.

One embodiment adds a unique code to electronic messages, such as but not limited to a randomly generated alpha-numeric string. The code does not need to be random, but sufficiently obfuscated to associate a specific e-mail with a specific person. As such, the terms code and verification code are not limited to a specific code type unless specifically noted as such.

The code can be located anywhere in the message, but one embodiment places the code in a footer of emails. If the user is concerned about the authenticity of the email, he or she can access the financial services company website. The user then provides the email code to a security center. The security center verifies the code and provides a notification to the user if the email was authentic. Authentication is based upon both the code and the user's access, or account, identification. That is, the financial services company maintains a database with valid codes and the corresponding user for the valid codes. When the user associated with the code requests validation the security center can issue some sort of messaging, such as “Email D983DJ3 is a valid PayPal ‘You've Got Cash’ email, sent Feb. 14, 2005.” Hackers are not able to reuse previously-sent codes because the code would have to match the logged-in user.

The security center of the institution stores the code, email type, date/time email was sent, and user in a security database. The code is added to sent emails, such as in an email footer template. An email validation field is added to a user accessible area of the company's website to provide validation services to logged in users. During a validation operation the email type, date/time, and user are retrieved based on the code from the database. If the user retrieved matched the user logged in, then the email code, email type and date/time sent can be provided to the user.

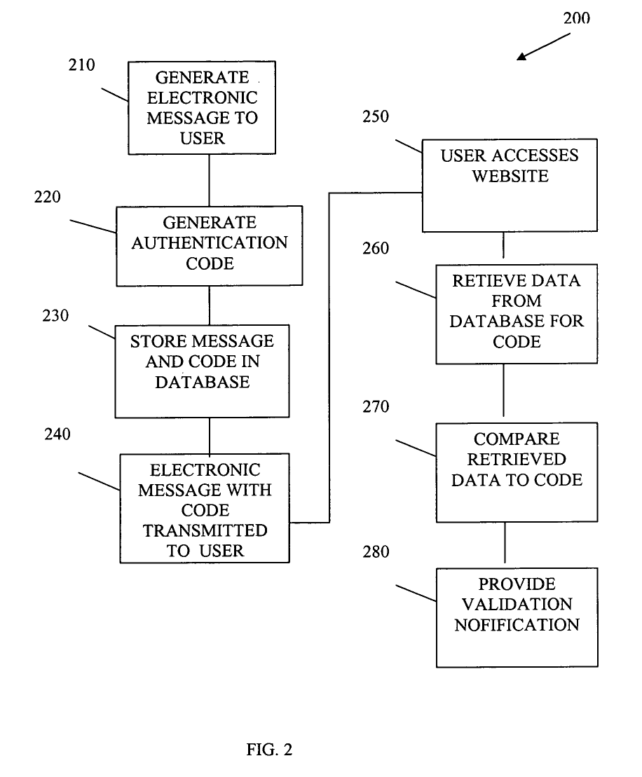

FIG. 2 illustrates a typical security and validation process 200 of an embodiment of the invention. At process 210 a financial service company generates an electronic message to a user. The message includes an authentication code generated at process 220. The code can be any type of code, for example a randomly generated number. The message data and code are stored 230 in a secure database.

The electronic message is communicated at process 240 to the user. In response, the user accesses 250 a website of the financial service company and provides the code from the message during a security validation operation. The information corresponding to the provided code is retrieved 260 from the database. The security validation operation compares the retrieved data to the user information (such as the user login or account number) at process 270. In response to a positive match, a validation notification and corresponding information about the original electronic message are provided at 280.

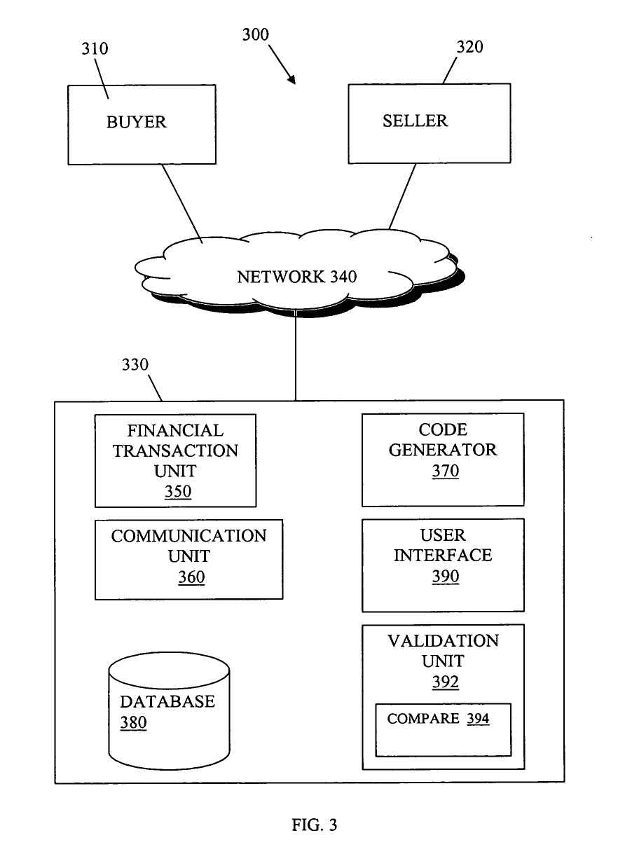

Referring to FIG. 3, a block diagram of a system 300 of embodiments of the invention is described. The system is network based to facilitate transactions between a seller 310, buyer 320 and a financial services company 330 via a network such as the Internet 340.

A financial transaction unit 350 is provided to execute an electronic commerce transaction between the buyer and the seller. The seller maintains an account with a financial services provider. It will be appreciated that the buyer can also maintain an account with the financial services provider. A communication unit 360 is provided to transmit an electronic message from the financial services provider to the seller. The electronic message includes a notification of the execution of the electronic commerce transaction and a verification code provided by a code generator 370. The communication unit can be a computer server operated by either the financial services company, or other third party on behalf of the financial services company. A data base 380 maintains records of the financial services company users, verification codes sent with electronic messages and data corresponding to the messages and financial transactions.

A user interface 390 accessible by the seller via the internet network is provided. The interface can be a graphical interface accessible through a web site operated by the financial services company. A user can access a validation unit 392 using the user's financial services account. The user provides the verification code received in an electronic message to the validation unit. The user can input the verification code by typing, copying from the message or otherwise communicate with the interface. The validation unit verifies that the financial services provider transmitted the electronic message to the user containing the verification code. A compare unit 394 of the validation unit can be provided to compare the recipient supplied code to the plurality of generated codes contained in the database. The compare unit compares an identification of the recipient that supplied the code with an identification of the recipient that the electronic message containing the code was transmitted to. The verification provided by the validation unit can be a message provided via the user interface indicating that a message to the user was transmitted and its corresponding information, such as a time stamp.

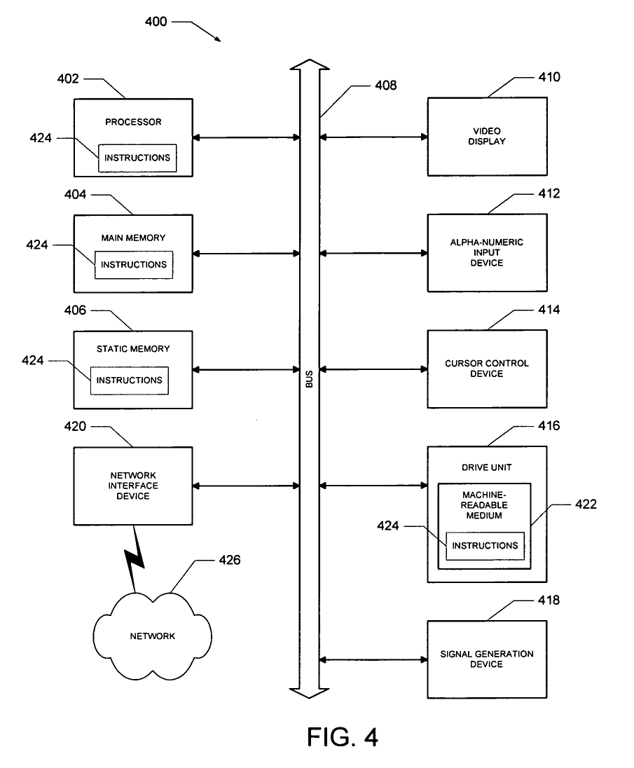

FIG. 4 shows a diagrammatic representation of a machine in the exemplary form of a computer system 400 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 400 includes a processor 402, a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alpha-numeric input device 412 (e.g. a keyboard), a cursor control device 414 (e.g. a mouse), a disk drive unit 416, a signal generation device 420 (e.g. a speaker) and a network interface device 422.

The disk drive unit 416 includes a machine-readable medium 424 on which is stored a set of instructions (i.e., software) 426 embodying any one, or all, of the methodologies described above. The software 426 is also shown to reside, completely or at least partially, within the main memory 404 and/or within the processor 402. The software 426 may further be transmitted or received via the network interface device 422. For the purposes of this specification, the term “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Thus, a system and method for providing electronic message validation have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
generating a verification code at a source;
transmitting an electronic message to a user from the source comprising the verification code;
providing a user interface accessible by the user, wherein the user interface is configured to allow the user to supply the verification code from the electronic message;
validating the verification code was generated by the source; and
providing a confirmation to the user that the electronic message was transmitted from the source to the user.

2. The method of claim 1 wherein the verification code is a randomly generated number.

3. The method of claim 1 where the source is a financial services company.

4. The method of claim 3 wherein the electronic message comprises a financial transaction confirmation.

5. The method of claim 1 wherein the user interface comprises a website interface accessible by the user via a network.

6. The method of claim 1 wherein validating the verification code comprises:
comparing the user supplied verification code to archived codes contained in a database; and
comparing an identification of the user that supplied the verification code to the user interface with an identification of the user that the electronic message containing the verification code was transmitted to.

7. The message of claim 6 wherein providing the confirmation is performed based upon an outcome of both the comparing the user supplied verification code and comparing the identification of the user operations.

8. A machine readable medium embodying instructions that, when executed by a machine, cause the machine to perform the method of claim 1.

9. A method comprising:
performing a financial transaction via a financial services company;
generating a verification code;
transmitting an electronic message to a user from the financial services company comprising the verification code and a confirmation of the financial transaction;
providing a network-based user interface accessible by the user via a network, wherein the user interface is configured to allow the user to supply the verification code from the electronic message;
validating the verification code was generated by the financial services company and transmitted to the user; and
providing a confirmation to the user that the electronic message was transmitted from the financial services company to the user.

10. The method of claim 9 wherein the verification code is a randomly generated number.

11. The method of claim 9 wherein validating the verification code comprises:
comparing the user supplied verification code to archived codes contained in a database;
comparing an identification of the user that supplied the verification code to the user interface with an identification of the user that the electronic message containing the verification code was transmitted to; and
wherein providing the confirmation is performed based upon an outcome of both the comparing the user supplied verification code and comparing the identification of the user operations.

12. A machine readable medium embodying instructions that, when executed by a machine, cause the machine to perform the method of claim 9.

13. A system comprising:
a code generation unit to generate a code;
a communication unit to transmit an electronic message to a recipient, wherein the electronic message comprises the code; and
a user interface accessible by the recipient, wherein the user interface is configured to allow the recipient to supply the code from the electronic message to a validation unit, wherein the validation unit verifies that the code was generated by the code generation unit and transmitted to the recipient.

14. The system of claim 13 wherein the validation unit further provides a confirmation to the recipient that the electronic message was transmitted from a financial services company to the recipient.

15. The system of claim 14 further comprising:
a database to archive a plurality of generated codes and electronic message data associated with each of the plurality of generated codes; and
a compare unit to compare the recipient supplied code to the plurality of generated codes contained in the database, wherein the compare unit further compares an identification of the recipient that supplied the code with an identification of the recipient that the electronic message containing the code was transmitted to.

16. The system of claim 15 wherein the user interface provides a recipient confirmation message based upon an output of the compare unit.

17. The system of claim 14 wherein the code generated by the code generation unit comprises a randomly generated number.

18. A network-based financial transaction system comprising:
a financial transaction unit to execute an electronic commerce transaction between a buyer and a seller via an internet network, wherein the seller maintains an account with a financial services provider;
a communication unit to transmit an electronic message from the financial services provider to the seller, wherein the electronic message comprises a notification of the execution of the electronic commerce transaction and a verification code; and
an user interface accessible by the seller via the internet network and the seller's account, wherein the user interface is configured to allow the seller to supply the verification code from the electronic message to a validation unit, wherein the validation unit verifies that the financial services provider transmitted the electronic message to the seller containing the verification code.

19. The network-based financial transaction system of claim 18 wherein the verification code comprises a randomly generated number.

20. The network-based financial transaction system of claim 18 wherein the electronic message comprises either an email, text message, voice message, or instant message.
